(19) United States
(12) Patent Application Publication
(10) Pub. No.: US 2007/0090158 A1
(43) Pub. Date: Apr. 26, 2007

(54) Method of fabricating foil brazing member

(75) Inventors: Haruhiko Watanabe, Chiryu-city (JP); Masaki Harada, Kariya-city (JP); Sumio Susa, Anjo-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/544,381

(22) Filed: Oct. 9, 2006

(30) Foreign Application Priority Data
Oct. 18, 2005 (JP) 2005-303666

(51) Int. Cl. A47J 36/02

(52) U.S. Cl. 228/101

(57) ABSTRACT

A method of fabricating a foil brazing member is disclosed and comprises the steps of ejecting molten metal of a brazing metal alloy onto a rotating metal cooling roll from at least an opening of a nozzle, cooling and solidifying the molten metal by the cooling roll and forcibly separating the cooled and solidified molten metal from the cooling roll into a thin band-shaped foil brazing member. The method further comprises the step of forming a plurality of empty portions on the molten metal being cooled and solidified, between the ejection step and the forcible separation step.

### BACKGROUND OF THE INVENTION

1. Field of the Invention
This invention relates to a method of fabricating a foil brazing member suitably used for brazing, for example, the tubes and the corrugated fins of a heat exchanger.

2. Description of the Related Art
A conventional method of fabricating a thin metal band using a roll method is known and is disclosed, for example, in Japanese Unexamined Patent Publication No. 2002-126855. In the roll method, a molten metal is continuously poured out in belt form from a nozzle onto a cooling roll rotating at high speed, rapidly solidified by quenching the cooling roll and after being forcibly separated from the roll, taken up as a thin band.

### SUMMARY OF THE INVENTION

In the case where the thin metal band fabricated by the method described above is used as a foil brazing member for brazing between the tubes and the corrugated fins of a heat exchanger, however, a greater part of the foil brazing member is left unused wastefully for brazing due to the fact that the tubes touch at only the bent portions of the corrugated fins.

In view of this problem, the object of this invention is to provide a method of fabricating a foil brazing member capable of brazing, without waste, two members partially in contact with each other at a plurality of points.

In order to achieve the object described above, this invention employs the technical means described below.

According to this invention, there is provided a method of fabricating a foil brazing member, comprising the steps of ejecting a molten metal of a brazing metal alloy onto a rotating metal cooling roll (230) from openings (221) of a nozzle (220), cooling and solidifying the molten metal by the cooling roll (230), and forcibly separating the cooled and solidified molten metal from the cooling roll (230) into a thin band-shaped foil brazing member (115), the method further comprising, between the ejection step and the forcible separation step, the step of forming a plurality of empty portions (115a) in the molten metal being cooled and solidified or having been cooled and solidified.

As a result, the foil brazing member (115) having a plurality of the empty portions (115a) can be easily formed. Specifically, the empty portions (115a) can be formed on the normal foil brazing member without any post-processing such as punching.

This foil brazing member (115) can be suitably used for brazing the tubes (111) and the corrugated fins (112) of a heat exchanger (100). Specifically, the tubes (111) and the corrugated fins (112) are brazed to each other with the foil brazing member (115) interposed therebetween. In the process, with the portion of the foil brazing member (115) sandwiched between the bent portion of the corrugated fins (112) and the tubes (111) as a starting point, the molten metal flows into the contact between the tubes (111) and the corrugated fins (112) by capillarity and thus the brazing is made possible. The portions of the foil brazing member (115) where the tubes (111) and the corrugated fins (112) are not in contact with each other and which constitute the empty portions (115a) correspond to the portions requiring no brazing member and, therefore, a wasteful use of the brazing member is eliminated.

According to this invention, there is provided a method of fabricating a foil brazing member wherein at least an opening (221) of the nozzle (220) is comprised of a plurality of openings (221) juxtaposed along the width of the thin band-shaped foil brazing member (115) and the step of forming the empty portions includes the step of adjusting the amount of the molten metal ejected from the plurality of the openings (221) in the ejection step.

As a result, the molten metal ejected from the plurality of the openings (221) is increased to more than a predetermined amount thereby to form a solid portion (115b) of the foil brazing member (115) connecting the plurality of the openings (221). Also, by setting the molten metal to a predetermined amount, the solid portion (115b) of the foil brazing member (115) corresponding to the plurality of the openings (221) can be formed.

Further, by reducing the amount of the molten metal from any one of the plurality of the openings (221) to zero, empty portions (115a) in the foil brazing member (115) can be formed. The empty portions (115a) can be formed in various shapes by changing the portions where, and the timing when, the amount of the molten metal from the plurality of the openings (221) is reduced to zero.

The amount of the molten metal can be adjusted by opening or closing the plurality of the openings (221) or by regulating the pressure applied to the molten metal in the nozzle.

According to this invention, there is provided a method of fabricating a foil brazing member wherein the step of forming the empty portions includes the step of partially cutting off the molten metal being cooled and solidified, from the cooling roll (230).

As a result, the empty portions (115a) can be easily formed during the process of forming the foil brazing member (115).

According to this invention, there is provided a method of fabricating a foil brazing member wherein the cooling roll (230) is provided with a plurality of depressions (232) on its circumferential surface (231), and the step of forming the empty portions includes the step of leaving on the cooling roll (230) the portions of the cooled and solidified molten metal that has entered the plurality of the depressions (232), in the forcible separation step.

By leaving part of the molten metal in the plurality of the depressions (221) in this way, the empty portions (115a) of the foil brazing member (115) can be easily formed in the forcible separation step.

According to this invention, there is provided a method of fabricating a foil brazing member, wherein the cooling roll (230) is provided with a plurality of portions (233, 234) relatively low in a cooling and solidification capacity on its circumferential surface (231), and the step of forming the empty portions includes the step of removing the insufficiently solidified portions at the plurality of portions (233, 234) relatively low in the cooling and solidification capacity, from the foil brazing member (115) in the forcible separation step.

By removing the insufficiently solidified portion (233, 234) low in the cooling and solidification capacity from the foil brazing member (115) in this way, the empty portions (115a) of the foil brazing member (115) can be easily formed in the forcible separation step.

The portion (233, 234) low in the cooling and solidification capacity can be formed as a portion (233) higher in temperature than the ordinary portion of the cooling roll (230) or as a portion (234) lower in heat conductivity than the ordinary portion of the cooling roll (230).

The reference numerals in the parentheses attached to each means indicates the correspondence with the specific means in the embodiments described later.

The present invention may be more fully understood from the description of preferred embodiments of the invention, as set forth below, together with the accompanying drawings.

### BRIEF DESCRIPTION OF THE DRAWINGS

FIG. 1 is a front view showing an intercooler to be brazed.

FIG. 2 is a sectional view taken in line A-A in FIG. 1.

FIG. 3 is a plan view showing a foil brazing member according to a first embodiment.

FIG. 4 is a schematic diagram showing a foil brazing member fabrication device according to the first embodiment.

FIG. 5 is a perspective view of a nozzle.

FIG. 6 is a plan view showing a foil brazing member according to a second embodiment.

FIG. 7 is a schematic diagram showing a foil brazing member fabrication device according to a third embodiment.

FIG. 8 is a schematic diagram showing a cooling roll according to a fourth embodiment of the invention.

FIG. 9 is a schematic diagram showing a cooling roll according to a fifth embodiment of the invention.

FIG. 10 is a perspective view showing a nozzle according to another embodiment.

### DESCRIPTION OF THE PREFERRED EMBODIMENTS

(First Embodiment)

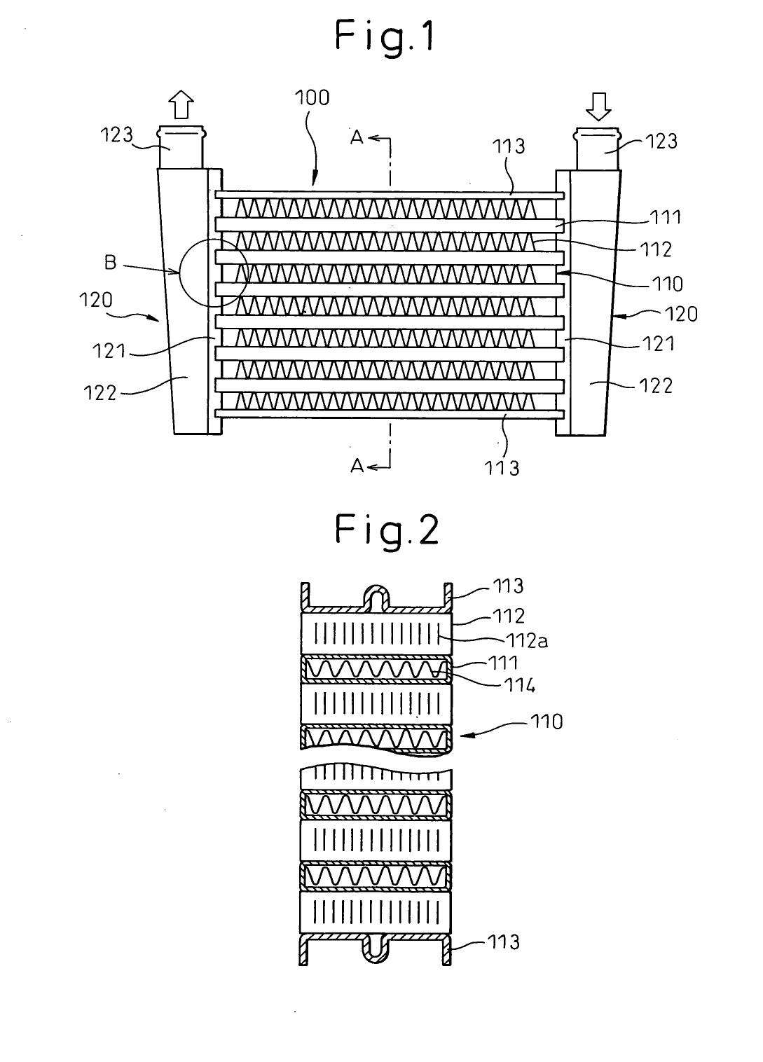

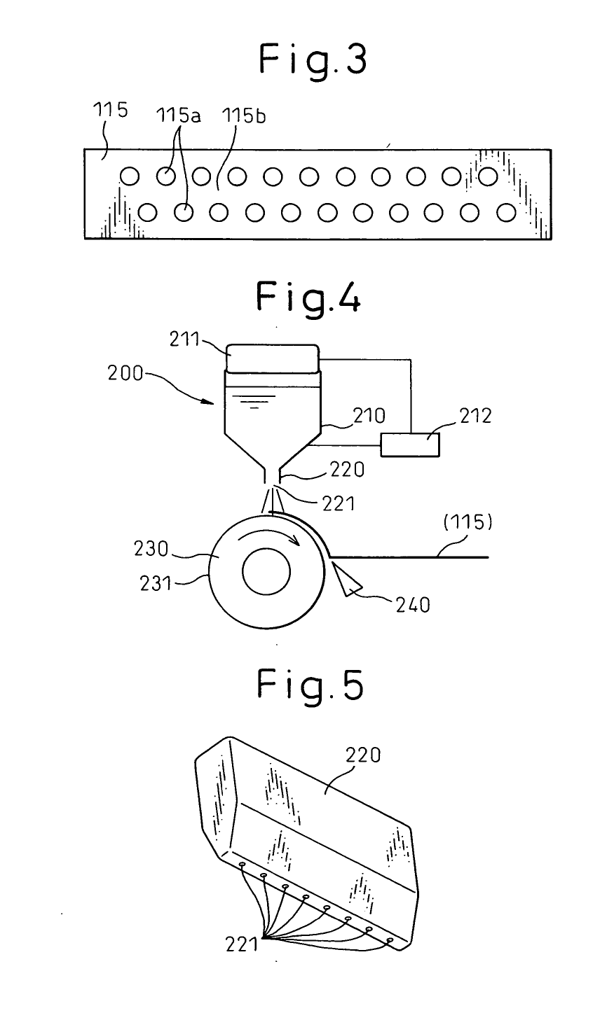

This embodiment is an application of the invention to a foil brazing member fabrication device 200 to fabricate a foil brazing member 115 used for brazing an air-cooled intercooler 100. This embodiment is explained below with reference to FIGS. 1 to 5. FIG. 1 is a front view showing the intercooler 100 to be brazed, FIG. 2 a sectional view taken in line A-A in FIG. 1, FIG. 3 a plan view showing the foil brazing member 115, FIG. 4 a schematic diagram showing the foil brazing member fabrication device 200, and FIG. 5 a perspective view of a nozzle 220.

First, the intercooler 100 to be brazed and the foil brazing member 115 used for it will be explained briefly. The intercooler 100 is a heat exchanger for cooling the combustion air (hereinafter referred to as the intake air) introduced into a vehicle engine (internal combustion engine) by heat exchange with an external cooling air. The intercooler 100, as shown in FIGS. 1 and 2, mainly includes a core unit 110 and a pair of header tanks 120. This embodiment assumes a large-sized intercooler 100 mounted on a large vehicle such as a truck. Each member described below, therefore, is made of copper, copper alloy or iron to secure a sufficient heat conductivity and a sufficient durability, and the contacting portions of the members are coupled by brazing or welding.

The brazing member (the foil brazing member 115 or the paste brazing member described later) used for the brazing process is a copper brazing member, which is formed of 75% copper, 15% tin, 5% nickel and 5% phosphor, for example, is low in melting point and has reducibility.

In the core unit 110, tubes 111, with inner fins 114 inserted therein, and outer fins 112 are stacked alternately, and a side plate 113 is arranged on each outermost surface of the stack.

The intake air flows in the tubes 111. In order to secure as large a sectional area as possible in a limited space and thus to reduce the flow resistance of the intake air, the tubes 111 have a flat rectangular cross section. The tubes 111, though not shown in detail in the sectional view of FIG. 2, are formed of pairs of plate members each bent into the shape of a channel having an intermediate portion longer than the end portions, in which the end portions of the channel are laid one on the other and brazed. In the shown case, the tubes 111 are formed of red brass containing 15% zinc and 0.8% iron.

The inner fins 114 inserted into the tubes 111, formed of a thin corrugated band of pure copper, have the effect of producing turbulence of the intake air flow and improve the heat conductivity to the intake air. In view of the flat rectangular section of the tubes 111, the inner fins 114 are efficiently accommodated in the tubes 111 without generating any dead space.

The outer fins 112, like the inner fins 114, are formed of a thin corrugated band of pure copper. The outer fins 112 have a plurality of louvers 112a cut in the flat surfaces thereof, so that the area of radiation to the cooling air is enlarged while, at the same time, producing turbulence and promoting heat exchange with the intake air.

The side plates 113 are reinforcing members of brass extending longitudinally to the tubes 111 and have substantially channel-shaped cross sections. At least a rib, extending in longitudinal direction, is formed at the inner central portion of each channel.

In the core unit 110, the tubes 111 and the inner fins 114 are brazed to each other with the foil brazing member 115 described later (FIG. 3), and the tubes 111 and the outer fins 112 are brazed to each other and the outer fins 112 and the side plates 113 are brazed to each other. Specifically, at the time of assembly, the foil brazing member 115 is interposed between the inner wall of the tube 111 and the inner fin 114, between the outer wall of the tube 111 and the outer fin 112 and between the outermost fin 112 and the side plate 113, so that the members 111, 112, 113 and 114 are brazed to each other by the foil brazing member 115. In the corrugated fins 112, 114, the bent portions are in contact with the mating members (tube 111, the side plate 113) and brazed at the contact portions. Also, the tube plate members forming the tube 111 are brazed to each other by the foil brazing member 115.

A pair of header tanks 120 extending along the direction of stack of the tubes 111 and communicating with the tubes 111 are arranged at the longitudinal ends of the tubes 111 (hereinafter referred to as the tube ends). The header tanks 120 each include a header plate 121, a tank body 122 and a pipe 123.

The header plates 121 are members each having an edge support erected on the tank body 122 on the outer periphery of the elongate flat plate, and have tube holes formed at the portions thereof corresponding to the tube ends. In this case, the material of the header plates 121 is iron, and the obverse and reverse surfaces thereof in the neighborhood of the tube holes other than the edge supports are plated (or clad) with pure copper.

The tube ends are fitted by being inserted into the tube holes, and by the paste brazing material (the brazing member formed of a mixture of the brazing member, flux and a binder) coated on the fitting portions, the tubes 111 and the header plates 121 are brazed to each other at the contact portions thereof. The longitudinal ends of the side plates 113 are brazed to the header plates 121 by the paste brazing material coated at the contact portions with the header plates 121.

The tank body 122 is an elongate half container open to the header plates 21 and formed of the same iron material as the header plates 121. Each open side of the tank body 122 is welded to the edge supports of the header plates 121 and forms an internal tank space.

The pipes 123 are formed of iron and are each welded to a longitudinal end of the tank body 122 in such a manner as to communicate with the internal tank space.

The right header tank 120 in FIG. 1 is for supplying the intake air flowing in from the pipe 123, distributively, to each tube 111, while the left header tank 120 in FIG. 1 collects and recovers the intake air flowing out of the tubes 111 and discharges it out of the pipe 123.

The foil brazing member 115 used for brazing the core unit 110 of the intercooler 100, as shown in FIG. 3, is formed as a thin band of the brazing material (for example, 20μm to 50μm thick), and a plurality of empty portions 115a are formed in a band-shaped solid portion 115b. The empty portions 115a are each formed as a circular hole and are formed in a plurality of rows staggered along the length of the band. Alternatively, the circular empty portions 115a may be formed in a plurality of rows juxtaposed along a longitudinal band.

The foil brazing member 115 described above is fabricated by the foil brazing member fabrication device (hereinafter referred to as the fabrication device) 200. The fabrication device 200, as shown in FIGS. 4 and 5, includes a melting furnace 210, a nozzle 220, pump means 211, control unit 212, a cooling roll 230 and a separation gas nozzle 240.

The melting furnace 210 is a vessel for melting and storing the brazing material alloy as a molten metal. Pressure is exerted on the molten metal and toward the nozzle 220 by, for example, a pump means 211 or the like. The operation of the pump means 211 is controlled by a control unit 212.

The nozzle 220 is arranged in the lower part of the melting furnace 210 so that the molten metal in the melting furnace 210 is ejected onto the cooling roll 230 from the openings 221 formed at the lower forward end. The nozzle 220 is formed in the shape of a flat wedge with a sharp forward end. A plurality of the circular openings 221 are arranged along the length of the flat nozzle 220. Also, among the plurality of the flow paths connected to the plurality of the openings 221 from the melting furnace 210, every other the flow path includes an on-off means (such as a valve mechanism) with the operation thereof controlled by a control unit not shown.

The nozzle 220 is arranged in proximity to the outer peripheral surface 231 at the upper end of the cooling roll 230 with the longitudinal direction thereof coinciding with the direction of the rotary axis of the cooling roll 230. The distance between the outermost of the plurality of the openings 221 is substantially equal to the width of the band-shaped foil brazing member 114.

The cooling roll 230, which is a flat cylindrical member of copper high in heat conductivity, is cooled and held at a predetermined cooling temperature capable of quenching the molten metal of the brazing material, and is adapted to be rotated at high speed (a peripheral speed of 100 km/h, for example) by a drive source (such as a motor), not shown. The thickness of the cooling roll 230 is larger than the length of the flat nozzle 220.

The separating gas nozzle 240, by applying the gas such as air, nitrogen or argon onto the cooling roll 230, forcibly separates the molten metal cooled and solidified on the outer peripheral surface 231 of the cooling roll 230 from the cooling roll 230. The separating gas nozzle 240 is arranged a predetermined distance away from the nozzle 220 in the direction of rotation of the cooling roll 230.

Next, the method of fabricating the foil brazing member 115 using the fabrication device 200 described above is explained.

First, the brazing material alloy is melted in the melting furnace 210 into a molten metal, to which a predetermined pressure is applied by the pump means thereby to eject the molten metal from the openings 221 of the nozzle 220 onto the circumferential surface 231 at the upper end of the cooling roll 230 (ejection step).

Next, by adjusting the amount of the molten metal ejected from the nozzle 220, the empty portions 115a are formed sequentially on the band-shaped inside area constituting a basic structure. Specifically, the amount of the molten metal is adjusted and the empty portions 115a are formed by opening and closing the on-off means in the nozzle 220. Specifically, every other on-off means in the nozzle 220 is opened and closed alternately for a predetermined time, so that the molten metal stops being supplied from the flow path with the on-off means thereof closed. In this way, the circular empty portions 115a are formed in staggered arrangement as explained with reference to FIG. 3 (empty portion forming step).

The molten metal ejected as described above is quenched and solidified on the circumferential surface 231 of the cooling roll 230 (cooling and coagulation step).

By applying the gas from the separating gas nozzle 240, the molten metal cooled and solidified on the outer peripheral surface 231 of the cooling roll 230 is forcibly separated and taken up as a roll of the foil brazing member 115 (forcible separation step).

The roll member thus taken up is cut to a predetermined length and formed into pieces of foil brazing member 115 for use in brazing the intercooler 100.

As described above, the fabrication device 200 according to this embodiment can adjust the amount of the ejected molten metal by opening and closing the on-off means arranged in the nozzle 20, and therefore the foil brazing member 115 having a plurality of empty portions 115a can be easily formed. Specifically, as compared with the ordinary foil brazing member, the empty portions 115a can be formed without post-processing such as punching.

In the case where the foil brazing member 115a is used for brazing the core unit 110 of the intercooler 100, that portion of the foil brazing member 115 interposed between the members which is held between the bent portions of the fins 112, 114 and the mating portion (the tubes 111, for example) functions as an origin and flows into the contact portions (tubes 111 and fins 112, 114) by capillarity, thereby making possible the brazing process. The portions where the members (tubes 111 and fins 112, 114) are out of contact with each other and which constitute the empty portions 115a of the foil brazing member 115, on the other hand, correspond to the portions requiring no brazing member and therefore wasteful use of the brazing member is prevented.

(Second Embodiment)

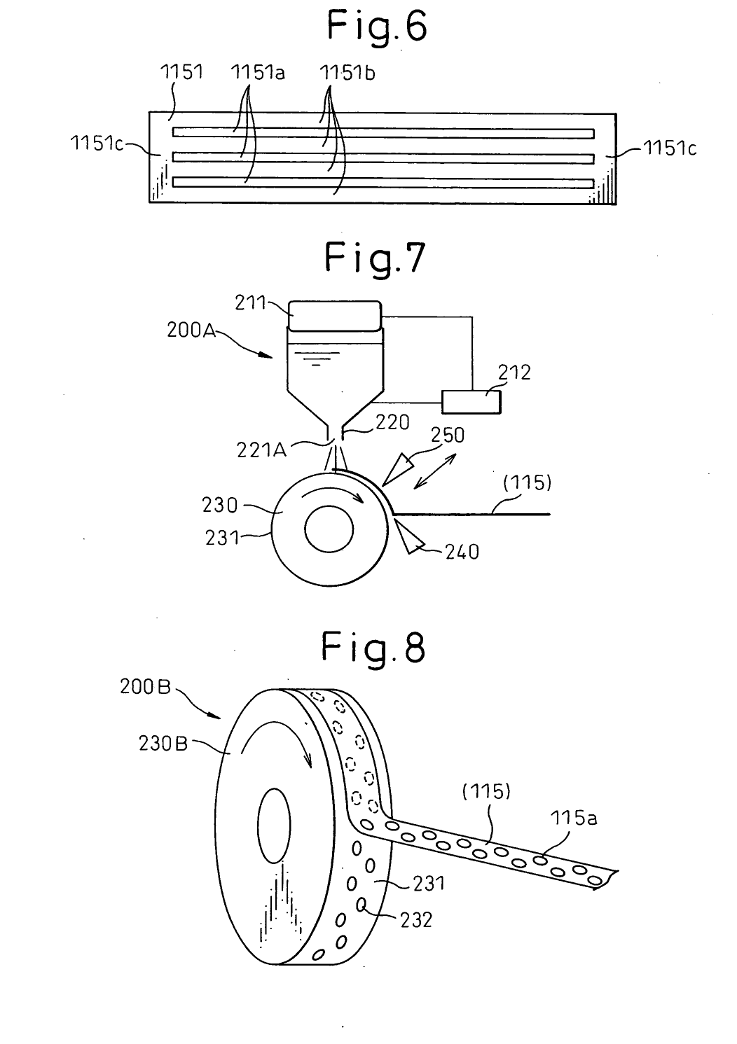

A second embodiment of the invention is shown in FIG. 6. According to the second embodiment, as compared with the first embodiment, the shape of the empty portions 1151a of the foil brazing member 115 is changed.

In this case, the empty portions 1151a of the foil brazing member 1151 are elongate instead of circular holes formed in a plurality of rows along the band length. With these elongate empty portions 1151a, the solid portion of the foil brazing member 1151 includes elongate solid portions 1151b formed at the longitudinal intermediate band portions and transversely-connected band-shaped solid portions 1151c formed at the longitudinal ends. The solid portion 1151c may be formed also at the longitudinal intermediate band portion.

In the case where the foil brazing member 1151 (empty portions 1151a) is formed, the on-off means in the nozzle 220 according to the first embodiment is not required, and instead, the pressure applied to the molten metal flowing toward the nozzle 220 from inside the melting furnace 210 is adjusted. Specifically, in order to form the solid portions 1151c, the pressure applied to the molten metal is increased beyond a predetermined level for a predetermined time to increase the amount of the molten metal ejected, so that the molten metal is connected transversely of the foil brazing member 1151. The solid portions 1151b, on the other hand, are formed by ejecting the molten metal from the nozzle 220 under the predetermined pressure. In the process, the empty portions 1151a are formed between the solid portions 1151b. This process is repeated.

As a result, the on-off means is eliminated and, as in the first embodiment, the foil brazing member 1151 having the empty portions 1151a can be easily fabricated by the fabrication device 200. Thus, the foil brazing member 1151, for brazing the intercooler 100 (core portion 110) without waste, is realized.

(Third Embodiment)

A third embodiment of the invention is shown in FIG. 7. According to the third embodiment, as compared with the first embodiment, the nozzle 220 of the fabrication device 200A is changed and cutting tools 250 are added.

The nozzle 220 has one opening 221A conforming with the flat forward end portion without the internal on-off means. The cutting tools 250 are for partially cutting off the molten metal being cooled and solidified on the circumferential surface 231 of the cooling roll 230. A plurality of the cutting tools 250 are arranged along the direction of the rotary axis of the cooling roll 230 movably in the radial direction of the cooling roll 230 between the nozzle 220 and the separating gas nozzle 240. The movement of the cutting tools 250 in radial direction is controlled by a control unit not shown.

According to the method of fabricating the foil brazing member 115 with the fabrication device 200A, the cutting tools 250 are moved to the proximity of the cooling roll 230 in radial direction in the cooling and coagulation process so that the molten metal being cooled and solidified on the circumferential surface 231 of the cooling roll 230 is partially cut off forcibly from the cooling roll 230 thereby to form the empty portions 115a of the foil brazing member 115. By setting the size of the cutting tools 250 and the time when the cutting tools 250 are moved to the proximity of the cooling roll 230, the size of the empty portions 115a can be adjusted. Also, by moving the cutting tools 250 away from the cooling roll 230, the molten metal and the cutting tools 250 are brought out of contact with each other, and the solid portion 115b is left on the foil brazing member 115. The size of this solid portion 115b can also be adjusted by setting the time during which the cutting tools 250 are separated from the cooling roll 230.

As a result, effects similar to the first embodiment are obtained. The chips generated by the cutting tools 250 are reusable by being recovered and charged into the melting furnace 210.

(Fourth Embodiment)

A fourth embodiment of the invention is shown in FIG. 8. According to the fourth embodiment, as compared with the first embodiment, the nozzle 220 and the cooling roll 230B of the fabrication device 200B are changed.

The nozzle 220, like that of the third embodiment described above, has one opening conforming to the flat forward end thereof, and the internal on-off means is eliminated. On the other hand, a plurality of depressions 232 corresponding in shape and position to the empty portions 115a of the foil brazing member 115 are formed on the circumferential surface 231 of the cooling roll 230B.

According to the method of fabricating the foil brazing member 115 with the fabrication device 200B, the forcible separation process with the separating gas nozzle 240 is executed in such a manner that the molten metal ejected into the depressions 232 of the cooling roll 230 is left in the depressions 232 and thus separated from the foil brazing member 115, thereby forming the empty portions 115a of the foil brazing member 115. As a result, similar effects to those of the fist embodiment are achieved.

According to this embodiment, the molten metal is left in the depressions 232 increasingly with the formation of the foil brazing member 115 and, therefore, must be removed periodically.

(Fifth Embodiment)

A fifth embodiment of the invention is shown in FIG. 9. According to the fifth embodiment, as compared with the fourth embodiment, the cooling roll 230C of the fabrication device 200C is changed.

A plurality of portions 233 having a relatively low cooling and solidification capacity, in the process of solidifying the molten metal, are formed on the circumferential surface 231C of the cooling roll 230C. The portions 233 relatively low in the cooling and solidification capacity are formed of, for example, a plurality of heaters 233 adjusted to provide a higher temperature than a predetermined cooling temperature at the ordinary portion of the cooling roll 230 by a control unit not shown. The heaters 233 are arranged in the shape and at the positions corresponding to those of the empty portions 115a of the foil brazing member 115.

In the method of fabricating the foil brazing member 115 by the fabrication device 200C described above, the molten metal ejected in the cooling and coagulation process is left insufficiently solidified by the heaters 233, and the insufficiently solidified portions drop off from the foil brazing member 115 and form the empty portions 115a of the foil brazing member 115 in the forcible separation process by the separating gas nozzle 240.

As a result, effects similar to those of the fourth embodiment are achieved. The molten metal dropped off due to insufficient coagulation can be reused by being recovered and charged into the melting furnace 210.

In the fifth embodiment described above, the portions 233 relatively low in cooling and solidification capacity can be changed to the portions 234 lower in heat conductivity than the ordinary portion of the cooling roll 230. Specifically, portions 234 lower in heat conductivity than the ordinary portion are arranged on the circumferential surface 231 of the cooling roll 230 in place of the heaters 233. The low heat conductivity portions 234 may be formed of iron, for example, in the case where the cooling roll 230 is formed of copper.

(Other Embodiments)

In each embodiments described above, the foil brazing member 115 is formed of copper. Nevertheless, the material is not limited to copper, and an aluminum or a nickel brazing member conforming with the base metal of the object to be brazed can alternatively be employed with equal effect.

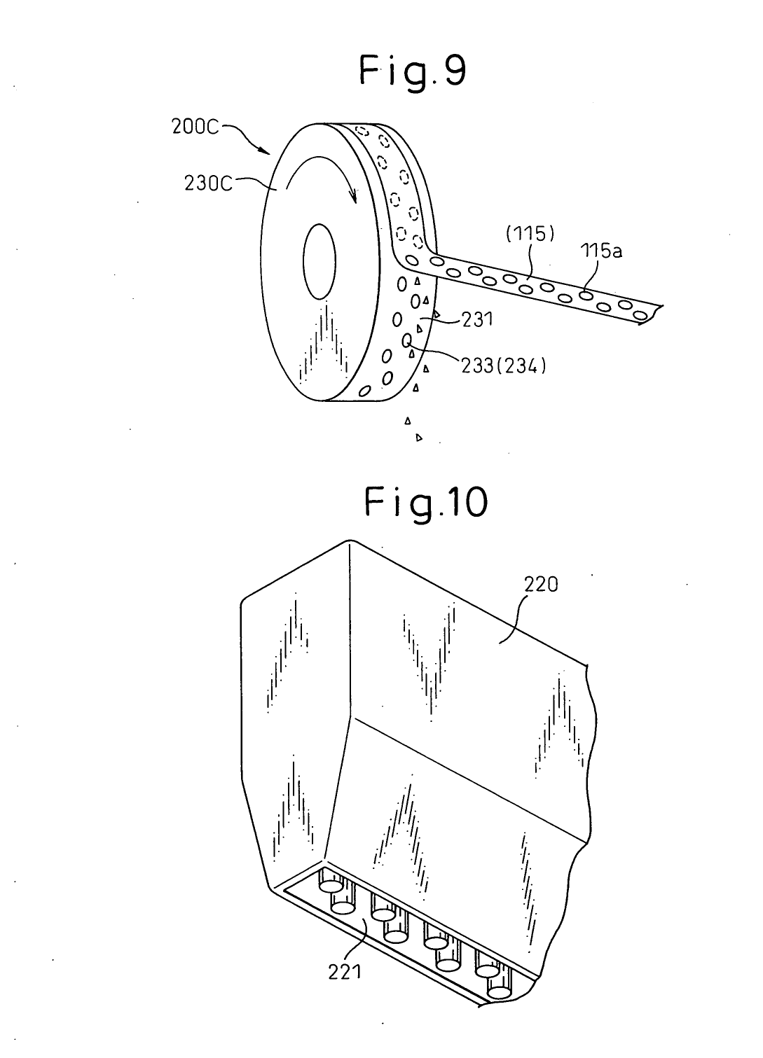

Also, instead of the circular openings 221 of the nozzle 220 of the fabrication device 200 in each embodiment (FIG. 5) described above, an inverted structure as shown in FIG. 10 may be employed in which the circular holes are left as pin-shaped solid portions and the surrounding portion forms an opening 221.

Also, the applicable product is not limited to the intercooler 100 but includes a radiator, a heater core, a condenser, etc. and the tubes and the corrugated fins can be brazed to each other according to the invention.

While the invention has been described by reference to specific embodiments chosen for purposes of illustration, it should be apparent that numerous modifications could be made thereto, by those skilled in the art, without departing from the basic concept and scope of the invention.

1. A method of fabricating a foil brazing member, comprising the steps of:
ejecting the molten metal of a brazing metal alloy onto a rotating metal cooling roll from at least an opening of a nozzle;
cooling and solidifying the molten metal by the cooling roll; and
forcibly separating the cooled and solidified molten metal from the cooling roll into a thin band-shaped foil brazing member;
the method further comprising the step of forming a plurality of empty portions in the molten metal being cooled and solidified, between the ejection step and the forcible separation step.

2. A method of fabricating a foil brazing member according to claim 1,
wherein the at least an opening of the nozzle is comprised of a plurality of openings juxtaposed along the width of the thin band-shaped foil brazing member, and the step of forming the empty portions includes the step of adjusting the amount of the molten metal ejected from the plurality of the openings in the ejection step.

3. A method of fabricating a foil brazing member according to claim 2,
wherein the amount of the molten metal is adjusted by opening and closing the plurality of the openings.

4. A method of fabricating a foil brazing member according to claim 2,
wherein the amount of the molten metal is adjusted by adjusting the pressure applied to the molten metal in the nozzle.

5. A method of fabricating a foil brazing member according to claim 1,
wherein the step of forming the empty portions includes the step of partially cutting off the molten metal being cooled and solidified, from the cooling roll.

6. A method of fabricating a foil brazing member according to claim 1,
wherein the cooling roll is provided with a plurality of depressions on its circumferential surface, and the step of forming the empty portions includes the step of leaving, on the cooling roll, those portions of the cooled and solidified molten metal which have entered the plurality of the depressions.

7. A method of fabricating a foil brazing member according to claim 1,
wherein the cooling roll is provided with a plurality of portions relatively low in the cooling and solidification capacity on its circumferential surface, and the step of forming the empty portions includes the step of removing the insufficiently solidified portions applied to the plurality of portions relatively low in the cooling and solidification capacity, from the foil brazing member in the forcible separation step.

8. A method of fabricating a foil brazing member according to claim 7,
wherein the portions low in the cooling and solidification capacity are higher in temperature than the ordinary portion of the cooling roll.

9. A method of fabricating a foil brazing member according to claim 7,
wherein the portions low in the cooling and solidification capacity are lower in heat conductivity than the ordinary portion of the cooling roll.
